(19) United States
(12) Patent Application Publication
(10) Pub. No.: US 2008/0192962 A1
(43) Pub. Date: Aug. 14, 2008

(54) Microphone with dual transducers

(75) Inventor: Aart Zeger Van Halteren, Hobrede (NL)

Correspondence Address: NIXON PEABODY, LLP, 161 N. CLARK ST., 48TH FLOOR, CHICAGO, IL, 60601-3213, US

(73) Assignee: Sonion Nederland B.V.

(21) Appl. No.: 12/069,684

(22) Filed: Feb. 12, 2008

Related U.S. Application Data
(60) Provisional application No. 60/889,740, filed on Feb. 13, 2007.

(51) Int. Cl. H04R 25/00

(52) U.S. Cl. 381/170

(57) ABSTRACT

Microphone is disclosed having unmatched electroacoustic transducers. The microphone may be a traditional ECM microphone, or it may be a MEMS microphone. Each of the unmatched electroacoustic transducers may have its own peak frequency selected so that the electroacoustic transducers together produce a desirable resultant peak frequency. The unmatched electroacoustic transducers may have different package sizes, front volumes, back volumes, and/or diaphragm tensions, thicknesses, lengths, widths, and/or diameters. In some embodiments, the microphone may have different backplate charging and/or output signal amplification schemes for the electroacoustic transducers. Where the microphone is a MEMS microphone, voltage generation and output signal amplification are provided by an integrated circuit that may be mounted either within a front volume of one of the electroacoustic transducers or adjacent to one of the electroacoustic transducers.

### CROSS REFERENCE TO RELATED APPLICATION

This application claims the benefit of U.S. Provisional Application No. 60/889,740, filed Feb. 13, 2007.

### FIELD OF THE INVENTION

The present invention relates generally to microphones and, more particularly, to a microphone having dual electroacoustic transducers.

### BACKGROUND OF THE INVENTION

A typical acoustic transducer, such as those used in microphones, includes a flexible diaphragm and a stiff backplate substantially parallel to the flexible diaphragm. The diaphragm divides the acoustic transducer into a front volume and a back volume and forms a capacitor with the backplate. For MEMS (micro electromechanical system) microphones, a voltage generator supplies and maintains a voltage on the backplate. An example of a MEMS microphone may be found, for example, in commonly-assigned U.S. Published Application No. 20040120540, which is incorporated herein by reference. No voltage generator is needed to maintain a voltage on the backplate of a traditional electret condenser microphone (ECM). In operation, sound waves impinging on the diaphragm cause it to move according to the pressure exerted by sound waves. The movement of the diaphragm induces fluctuations in the voltage on the backplate that are detected as electrical signals by an amplifier. The amplifier amplifies these signals and passes them to other electronic components internal and/or external to the microphone for processing.

With both MEMS microphones and traditional electret condenser microphones, the challenge is to improve the signal-to-noise ratio. One way that this can be accomplished is by providing a microphone system with very little acoustical resistance. Unfortunately, low acoustical resistance results in very high undamped peak frequencies. In general, the peak frequency of a microphone used, for example, in a hearing aid should be between 9 and 15 kHz for optimum performance. The 9 kHz lower limit is dictated by the bandwidth requirement of applications such as hearing aids. Most hearing aids need to have the peak frequency above 6 kHz, with higher peak frequencies being preferred. Peak frequencies higher than 15 kHz, however, can result in overload of the microphone in the presence of an ultrasonic signal. For example, a 25 to 40 kHz signal can have a magnitude of 110 dB SPL (sound pressure level) or more, which can overload the microphone.

Accordingly, what is needed is a microphone that overcomes the above peak frequency problem and other problems. In particular, what is needed is a microphone that provides improved signal-to-noise ratio while maintaining a peak frequency and/or amplitude that lies within an acceptable range.

### SUMMARY OF THE INVENTION

The present invention is directed to a microphone having unmatched electroacoustic transducers. The microphone may be a traditional ECM microphone, or it may be a MEMS microphone. Each of the unmatched electroacoustic transducers may have its own peak frequency selected so that the electroacoustic transducers together produce a desirable resultant peak frequency. The unmatched electroacoustic transducers may have different package sizes, front volumes, back volumes, and/or diaphragm tensions, thicknesses, lengths, widths, and/or diameters. In some embodiments, the microphone may have different backplate charging and/or output signal amplification schemes for the electroacoustic transducers. Where the microphone is a MEMS microphone, voltage generation and output signal amplification are provided by an integrated circuit that may be mounted either within a front volume of one of the electroacoustic transducers or adjacent to one of the electroacoustic transducers.

In general, in one aspect, the invention is directed to a microphone assembly. The assembly comprises a first electroacoustic transducer having a first peak frequency and a second electroacoustic transducer having a second peak frequency connected in electrical parallel to the first electroacoustic transducer. The second peak frequency is substantially different from the first peak frequency by a predetermined minimum amount such that the two peak frequencies produce a desirable resultant peak frequency for the microphone.

In general, in another aspect, the invention is directed to a microphone. The microphone comprises a first electroacoustic transducer having a first peak frequency and a second electroacoustic transducer having a second peak frequency and connected in electrical parallel to the first electroacoustic transducer. The microphone further comprises at least one voltage generator connected to one or more of the first and second electroacoustic transducers and at least one amplifier connected to one or more of the first and second electroacoustic transducers. The second peak frequency is substantially different from the first peak frequency by a predetermined minimum amount such that the two peak frequencies produce a desirable resultant peak frequency for the microphone.

In general, in yet another aspect, the invention is directed to a method of assembling a microphone. The method comprises mounting a first electroacoustic transducer having a first peak frequency on a substrate and mounting a second electroacoustic transducer having a second peak frequency on the substrate in electrical parallel to the first electroacoustic transducer. The second peak frequency is substantially different from the first peak frequency by a predetermined minimum amount such that the two peak frequencies produce a desirable resultant peak frequency for the microphone assembly.

In another aspect of the invention, there is provided a microphone assembly, comprising a first electroacoustic transducer adapted to produce a first electrical output signal, and a second electroacoustic transducer adapted to produce a second electrical output signal. The microphone assembly further comprises one or more bias voltage generators adapted to provide first and second DC bias voltages of opposing polarity to said first and second electroacoustic transducer, respectively, and an amplifier is electrically connected to the first and second electrical output signals to provide an amplifier output signal derived from the first and second electrical output signals. Preferably, the one or more bias voltage generators and the amplifier are integrated on a single semiconductor substrate, such as a sub-micron CMOS integrated circuit, that additionally comprises a pair of input pads for interconnection to the first and second electroacoustic transducer and an output pad for conveying a microphone assembly output signal.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

The foregoing and other advantages of the invention will become apparent from the following detailed description and upon reference to the drawings, wherein:

FIGS. 1A-1 is a graphical comparison of the noise damping for the matched versus unmatched transducers at a peak amplitude of 5 dB and also illustrates the noise damping for a single transducer;

FIGS. 1A-1B are a perspective view and a cross-sectional view, respectively, of an exemplary MEMS microphone having an integrated circuit mounted within a front volume of one of the acoustic transducers according to embodiments of the invention;

FIG. 2 is a perspective view of an exemplary MEMS microphone having an integrated circuit mounted adjacent to one of the acoustic transducers according to embodiments of the invention;

FIG. 3 is a perspective view of an exemplary MEMS microphone where one of the acoustic transducers has a different package size according to embodiments of the invention;

FIG. 4 is a perspective view of an exemplary MEMS microphone where the acoustic transducers have different diaphragm diameters according to embodiments of the invention;

FIG. 5 is a perspective view of an exemplary MEMS microphone where the acoustic transducers have different diaphragm thicknesses according to embodiments of the invention;

FIG. 6 is a perspective view of an exemplary MEMS microphone where the acoustic transducers have different back volumes according to embodiments of the invention;

FIG. 7 is a perspective view of an exemplary MEMS microphone where the acoustic transducers have different front volumes according to embodiments of the invention; and

FIGS. 8-20 are diagrams of exemplary microphone assemblies having different voltage generators and output signal amplification schemes according to embodiments of the invention.

### DESCRIPTION OF ILLUSTRATIVE EMBODIMENTS OF THE INVENTION

Following is a detailed description of various embodiments of the invention with reference to the drawings. It should be noted that the drawings are provided for illustrative purposes only and are not intended to be manufacturing drawings or blueprints, nor are they drawn to any particular scale.

As mentioned previously, the peak frequency of a microphone should be between 9 and 15 kHz for optimum performance in applications such as hearing aids. In accordance with embodiments of the invention, a desirable peak frequency may be achieved by providing a single microphone with two electroacoustic transducers, each transducer having a peak frequency that is separated from the other peak frequency by a predetermined minimum amount. The deliberate and specific use of unmatched electroacoustic transducers can produce a desirable resultant peak frequency without compromising the amount of noise damping for the microphone. Such an arrangement is in contradistinction to the case where the electroacoustic transducers are unmatched purely by happenstance (e.g., they were fabricated on different wafers). Furthermore, by using two (or more) unmatched transducers, the peak response of the microphone can be reduced. This means that, for any peak frequency of a given amplitude, less damping is required, and thus lower damping noise is introduced, if the peak frequency is achieved using two (or more) unmatched transducers versus using either a single transducer or two matched transducers.

Table 1 below shows the damping noise improvement that may be obtained using two (or more) unmatched transducers versus two matched transducers. The transducers are assumed to be otherwise identical except for the matched and unmatched frequencies. In Table 1, Sₚₖ is the peak amplitude of the two matched transducers, while “ripple” represents the peak amplitudes of the two unmatched transducers (which are equal to Sₚₖ as well as to each other). Likewise, Q₀ is the Q of the two matched transducers, while Q₁ & Q₂ are the Qs of the two unmatched transducers. Similarly, ω₀ is a multiple of the peak angular frequency of the two matched transducers, while ω₁ & ω₂ are multiples of the peak angular frequencies of the two unmatched transducers. For both matched and unmatched transducers, the damping noise is proportional to the square root term shown in Table 1. Note that in the particular implementation illustrated in Table 1, the angular frequencies ω₁ & ω₂ of the two unmatched transducers are spaced apart by a substantially symmetrical distance about the peak frequency. Note also that this distance varies from about 0.72 times the peak frequency at a peak amplitude of 3 dB to about 0.40 times the peak frequency at a peak amplitude of 10 dB. As can be seen, the improvement in damping noise ranges from about 1.3 dB at a peak amplitude of 3 dB to about 2.5 dB at a peak amplitude of 10 dB. Of course, the invention is not limited to the specific implementation shown in Table 1, but rather those having ordinary skill in the art will recognize that other ranges, both symmetrical and non-symmetrical about the peak frequency, may be used for the frequencies ω₁ & ω₂ of the two unmatched transducers.

TABLE 1

| | | | | | | | | | |
|---|---|---|---|---|---|---|---|---|---|
| Dual | Spk [dB] | 3 | 4 | 5 | 6 | 7 | 8 | 9 | 10 |
| matched | ω₀ | 1.19 | 1.14 | 1.10 | 1.08 | 1.06 | 1.04 | 1.03 | 1.03 |
| | Q₀ | 1.30 | 1.49 | 1.70 | 1.93 | 2.18 | 2.46 | 2.77 | 3.12 |
| | ω₀Q₀ | 1.55 | 1.70 | 1.87 | 2.07 | 2.30 | 2.57 | 2.87 | 3.20 |
| | $\frac{2}{{Q}_{0} {ω}_{0}}$ | 1.29 | 1.18 | 1.07 | 0.97 | 0.87 | 0.78 | 0.70 | 0.62 |
| | $\sqrt{\frac{2}{{Q}_{0} {ω}_{0}}}$ | 1.14 | 1.09 | 1.03 | 0.98 | 0.93 | 0.88 | 0.84 | 0.79 |
| Shifted | ripple [dB] | 3 | 4 | 5 | 6 | 7 | 8 | 9 | 10 |
| peaks | ω₁ | 0.76 | 0.76 | 0.79 | 0.80 | 0.81 | 0.81 | 0.82 | 0.83 |
| | Q₁ | 1.88 | 2.27 | 2.61 | 3.05 | 3.57 | 4.15 | 4.79 | 5.51 |
| | ω₂ | 1.48 | 1.43 | 1.35 | 1.30 | 1.28 | 1.26 | 1.25 | 1.23 |
| | Q₂ | 2.71 | 3.06 | 3.40 | 3.82 | 4.31 | 4.86 | 5.48 | 6.17 |
| | ω₁Q₁ | 1.42 | 1.72 | 2.06 | 2.44 | 2.88 | 3.37 | 3.92 | 4.55 |
| | ω₂Q₂ | 4.01 | 4.38 | 4.57 | 4.98 | 5.53 | 6.15 | 6.82 | 7.58 |
| | $\frac{1}{{Q}_{1} {ω}_{1}} + \frac{1}{{Q}_{2} {ω}_{2}}$ | 0.95 | 0.81 | 0.70 | 0.61 | 0.53 | 0.46 | 0.40 | 0.35 |
| | $\sqrt{\frac{1}{{Q}_{1} {ω}_{1}} + \frac{1}{{Q}_{2} {ω}_{2}}}$ | 0.98 | 0.90 | 0.84 | 0.78 | 0.73 | 0.68 | 0.63 | 0.59 |

| | | | | | | | | |
|---|---|---|---|---|---|---|---|---|
| Noise improvement [dB] | 1.3 | 1.6 | 1.8 | 2.0 | 2.2 | 2.3 | 2.4 | 2.5 |

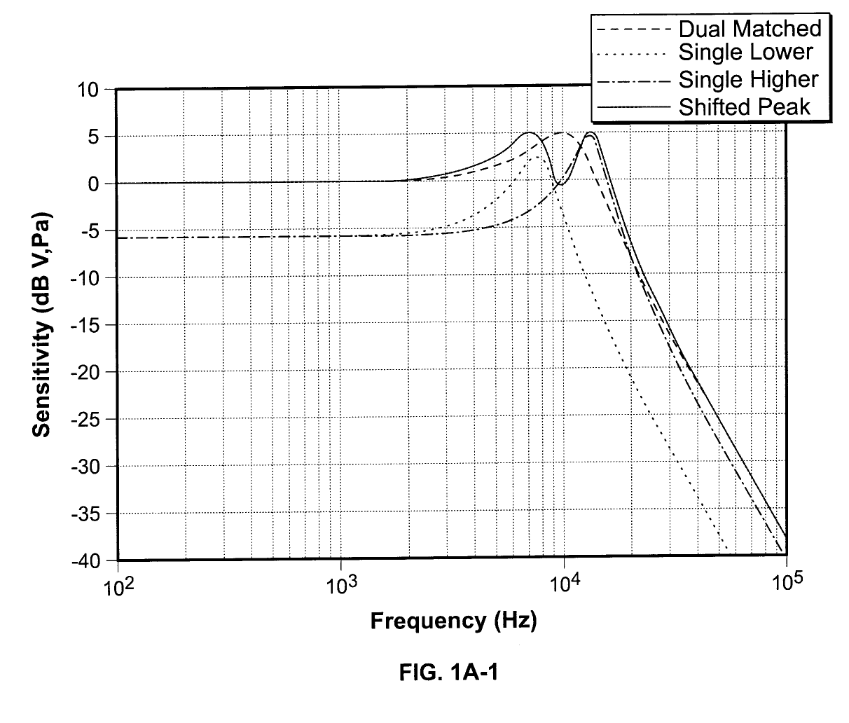

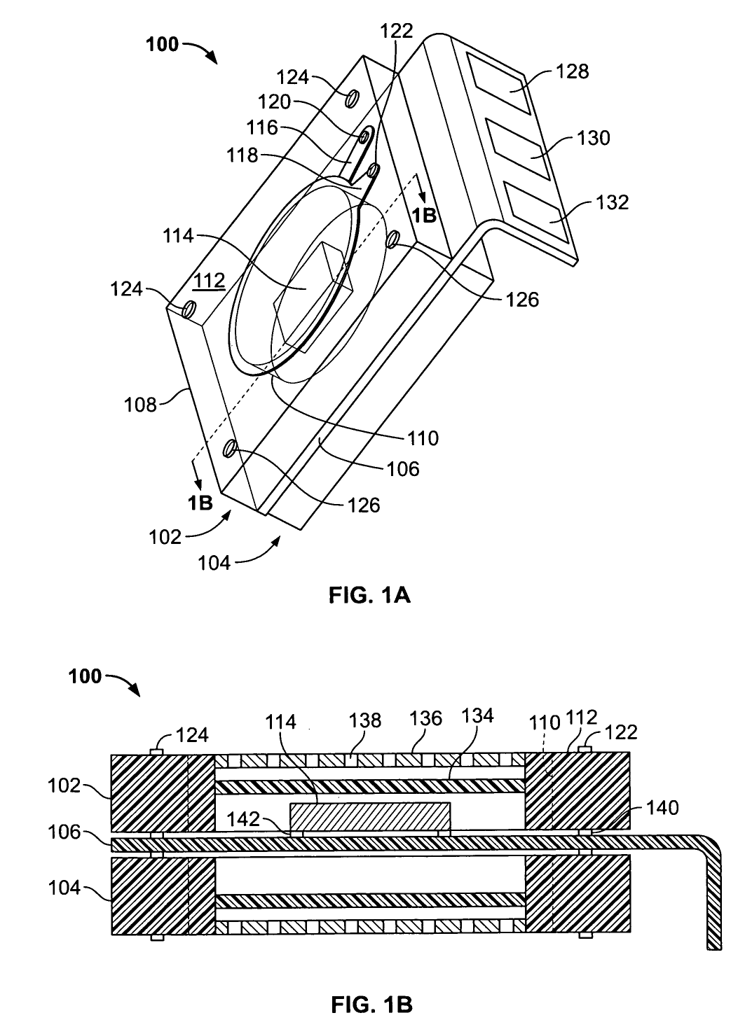

FIG. 1A-1 graphically compares the noise damping for the matched versus unmatched transducers at a peak amplitude of 5 dB and also shows the noise damping for instances where a single transducer is used.

The microphone may be a traditional electret condenser microphone, or it may be a MEMS microphone. In either case, deliberately using two unmatched electroacoustic transducers can result in a lower amount of noise for the microphone for substantially the same peak frequency heights compared to two transducers with the same peak frequency and the same peak frequency heights. The unmatched electroacoustic transducers also result in the noise being more spread out (i.e., the “Q” of the noise is lower), which improves the quality of the output produced by the microphone.

In some embodiments, the two unmatched electroacoustic transducers are connected in electrical parallel to each other, with either the front volumes or the back volumes of the electroacoustic transducers opposing one another. Where the microphone is a MEMS microphone, the two unmatched electroacoustic transducers may be mounted front-to-front and an integrated circuit containing the voltage generator and the amplifier may be mounted within the front volume of one electroacoustic transducers. Where the microphone is a traditional electret condenser microphone, no voltage generator is necessary. In some embodiments, the two unmatched electroacoustic transducers may have different diaphragm tensions, thicknesses, and/or diameters. In the latter case, the integrated circuit may be mounted adjacent to the electroacoustic transducer having the smaller diameter for a MEMS microphone. In some embodiments, the microphone may have different backplate charging and/or output signal amplification schemes for the two electroacoustic transducers. These various backplate charging and/or output signal amplification schemes may be used to balance differences in the sensitivities of the electroacoustic transducers.

Referring now to FIG. 1A, a perspective view of a MEMS microphone 100 having unmatched electroacoustic transducers according to embodiments of the invention is shown. The MEMS microphone 100 may be a silicon-based microphone, or it may be made of some other suitable MEMS material, such as glass. As can be seen, the microphone 100 includes two electroacoustic transducers 102 & 104 having substantially the same package size and mounted substantially across from one another on opposing sides of a substrate or carrier, such as a flex-print strip 106. The two electroacoustic transducers 102 & 104 have different peak frequencies and are mounted so that they are electrically parallel to each other, with their front volumes facing one another through the flex-print strip 106. Sound waves enter the electroacoustic transducers 102 & 104 primarily through the space between the electroacoustic transducers and the flex-print 106. Only one of the electroacoustic transducers, namely, the first electroacoustic transducer 102, is described in detail here, since the two electroacoustic transducers 102 & 104 are similar to each other in function and structure.

In one implementation, the electroacoustic transducer 102 may be an ordinary MEMS electroacoustic transducer known to those having ordinary skill in the art. Such an electroacoustic transducer 102 typically includes a glass or silicon-based housing 108 having an annular wall 110 formed therein. The annular wall 110 defines a cylindrical cavity within the housing 108 that is substantially normal to a back surface 112 of the housing 108. The cylindrical cavity, in turn, cuts an opening in a front surface (not visible here) of the housing 108 through which sound waves may enter the electroacoustic transducer 102. A flexible diaphragm 134 and a stiff backplate 136 (better seen in FIG. 1B) are formed within the cylindrical cavity parallel to one another and substantially coaxial with the cylindrical cavity.

In accordance with embodiments of the invention, an integrated circuit 114 is mounted on the flex-print strip 106 within the cylindrical cavity defined by the annular wall 110 of the housing 108. The integrated circuit 114, which may be an ASIC, provides the voltage and output signal amplification for the two electroacoustic transducers 102 & 104. Preferably, the package dimensions of the integrated circuit 114 are sufficiently small so as to not alter the acoustic all properties of the electroacoustic transducer in any significant way. In one implementation, the integrated circuit 114 may have package dimensions that measure approximately 0.10 mm thick by 0.6 mm wide and 1.5 0.6 mm long. Conductive traces 116 and 118 connect the flexible diaphragm 134 and the stiff backplate 136, respectively, to the integrated circuit 114 through leads 120 and 122 disposed on the back surface 112 of the housing 108. Although not expressly shown, each lead 120 and 122 has a respective electrical connection (e.g., via, wire bond, etc.) to the integrated circuit 114. One or more leads 124 and 126 on the back surface 112 of the housing 108 provide ground and power connections, respectively, to the integrated circuit 114. Conductive pads 126, 128, and 130 on the flex-print strip 106 allow the two electroacoustic transducers 102 & 104 to be connected to each other as well as other electronic components of the microphone 100.

FIG. 1B illustrates a cross-sectional view of the microphone 100 along line B-B. As can be seen here, the integrated circuit 114 is mounted inside the cylindrical cavity defined by the annular wall 110 of the electroacoustic transducer 102. The flexible diaphragm 134 and a stiff backplate 136 are also disposed within the cylindrical cavity (substantially parallel to one another and coaxial with the cylindrical cavity). The flexible diaphragm 134 and the stiff backplate 136 are supported by or otherwise attached to the annular wall 110 in a manner known to those having ordinary skill in the art. In some cases, perforations 138 may be formed in the backplate 136 to allow sound waves to exit the electroacoustic transducer 102. If the electroacoustic transducer 102 is enclosed within a housing or casing (not expressly shown), then the sound waves exit into a back volume defined by the backplate 136 and the housing or casing. Otherwise, the sound waves simply exit into open air. A set of solder bumps 140 allow the electroacoustic transducer 102 to be mounted on the flex-print strip 106. A similar set of solder pumps 142 allows the integrated circuit 114 to be mounted on and connected to the flex-print strip 106.

Although the integrated circuit 114 is shown as being mounted in the first electroacoustic transducer 102, it should be clear to those having ordinary skill in the art that the integrated circuit 114 may also be mounted in the second electroacoustic transducer 104. It should also be clear that each electroacoustic transducer 102 & 104 may have a separate integrated circuit 114 mounted within its respective cylindrical cavity without departing from the scope of the invention. In addition, although a circular diaphragm 134 and backplate 136 have been shown, the diaphragm 134 and/or backplate 136 may certainly assume other suitable shapes if needed, including rectangular shapes. In one embodiment, the diaphragm 134 and backplate 136 may be made in accordance with U.S. Pat. No. 6,859,542, which is incorporated herein by reference. Furthermore, although the substrate or carrier has been described as a flex-print strip 106, other non-flexible substrates or carriers, such as printed circuits boards, may also be used. Indeed, in some embodiments, the substrate or carrier may be a glass or silicon-based layer, thus allowing the microphone to be made entire of a semiconductor in material. Finally, although the electroacoustic transducers 102 & 104 are shown and described as having substantially the same package sizes, different package sizes may certainly be used without departing from the scope of the invention. Note that the dimensions of the diaphragms and the backplates do not necessarily track the package sizes and may be the same for different package sizes and vice versa.

FIG. 2 illustrates a perspective view of another MEMS microphone 200 having unmatched electroacoustic transducers according to embodiments of the invention. The microphone 200 is similar to the microphone 100 of FIGS. 1A-1B insofar as it includes unmatched electroacoustic transducers 202 & 204 having substantially the same package size and mounted facing each other on opposite sides of a flex-print strip 206. Unlike the microphone 100 of FIGS. 1A-1B, however, the microphone 200 of FIG. 2 has an integrated circuit 208 that is mounted adjacent to one of the electroacoustic transducers 202 & 204 on the flex-print strip 206. In the example shown, the integrated circuit 208 has package dimensions of approximately 3.1 mm long by 0.4 mm wide by 0.15 mm thick and is mounted adjacent to a front end 210 of the first electroacoustic transducer 202. It is of course possible to mount the integrated circuit 208 adjacent to a rear end 212 of the first electroacoustic transducer 202, or even to the second electroacoustic transducer 204, or both electroacoustic transducers 202 & 204 may have their own integrated circuit 208 mounted adjacent thereto. Electrical connections between the electroacoustic transducers 202 & 204, the flex-print strip 206, and the integrated circuit 208 may be implemented in a manner similar to that described with respect to FIGS. 1A-1B.

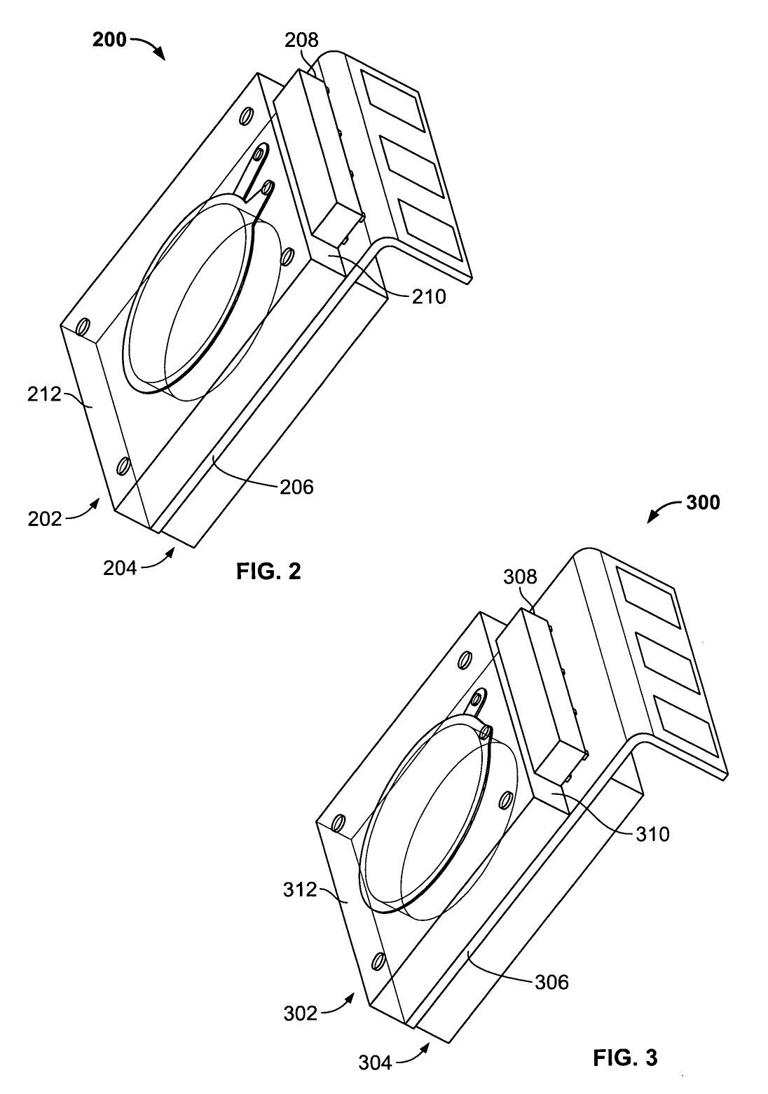

In the embodiments of FIGS. 1 and 2, the unmatched electroacoustic transducers 102 & 104 and 202 & 204 are shown and described as having substantially the same package sizes. FIG. 3 illustrates a perspective view of a MEMS microphone 300 wherein the package sizes of the unmatched electroacoustic transducers are different according to embodiments of the invention. As can be seen, the microphone 300 is similar to the microphone assemblies 100 and 200 of FIGS. 1A-1B and 2 in that it includes two unmatched electroacoustic transducers 302 & 304 mounted facing each other on opposite sides of a flex-print strip 306. In FIG. 3, however, one of the electroacoustic transducers, for example, the first electroacoustic transducer 302, has a package size that is smaller in one direction, for example, along the length of the flex-print strip 306, than the second electroacoustic transducer 304. The smaller package size of the first electroacoustic transducer 302 leaves more room on the flex-print strip 306 for mounting other components, such as an integrated circuit 308. In one example, the integrated circuit 308 may be placed adjacent to a front end 310 of the first electroacoustic transducer 302. In another example, the integrated circuit 308 may be placed adjacent to a rear end 312 of the first electroacoustic transducer 302. Alternatively (or in addition), the first electroacoustic transducer 302 may be smaller in the width direction of the flex-print strip 306, in which case the integrated circuit 308 may be mounted to one side of the electroacoustic transducer 302.

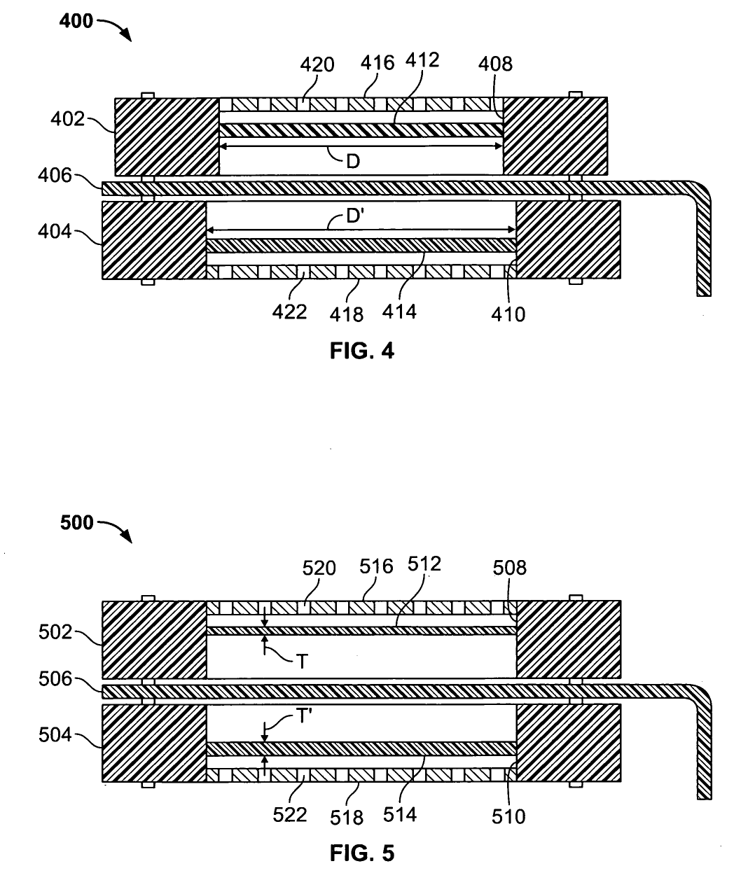

In addition to different package sizes, in some instances, it may be desirable to have one electroacoustic transducer where the diaphragm and/or backplate has one or more characteristics (e.g., tension, length, width, diameter, and/or thickness) that are different from the other electroacoustic transducer. As is well known to those having ordinary skill in the art, a diaphragm with one set of characteristics produces a peak frequency that is different from a diaphragm with another set. In a dual electroacoustic transducer arrangement, the different peak frequencies produce a resultant peak frequency that is often more desirable than the individual peak frequencies. This phenomenon allows acoustic-sensor manufacturers to achieve a desirable resultant peak frequency by mixing and matching the characteristics of the diaphragms for one or both of the electroacoustic transducers, as illustrated in FIGS. 4-5.

FIG. 4 illustrates a cross-sectional view of a MEMS microphone 400 where the unmatched electroacoustic transducers have diaphragms with different dimensional characteristics. The diaphragms in the present example are round and, therefore, the diameter of the diaphragms is the most relevant dimensional characteristic. It should be clear, however, that the teachings of the invention are fully applicable to other diaphragm shapes as well, including rectangular shapes. The microphone 400 is similar to the previous microphone assemblies (see FIGS. 1A-1B, 2, 3) in that it includes two electroacoustic transducers 402 & 404 mounted facing each other on opposite sides of a flex-print strip 406. Each electroacoustic transducer 402 & 404 has a respective annular wall 408 & 410 formed therein that defines a cylindrical cavity within each electroacoustic transducer 402 & 404. Flexible diaphragms 412 & 414 and stiff backplates 416 & 418 are disposed within the respective cylindrical cavities substantially parallel to one another and coaxial with each cylindrical cavity. The backplates 416 & 418 have perforations 420 & 422 formed therein for frequency damping purposes. Although not expressly shown, an integrated circuit may also be present. The integrated circuit may be mounted on the flex-print strip 406, either within the cylindrical cavity of one of the electroacoustic transducers 402 & 404 (see FIGS. 1A-1B) or adjacent to one of the electroacoustic transducers 402 & 404 (see FIGS. 2-3).

In accordance with embodiments of the invention, the diaphragms 412 & 414 may have different diameters. For example, the diaphragm 412 in the first electroacoustic transducer 402 may have a diameter D that is smaller than a diameter D′ of the diaphragm 414 in the second electroacoustic transducer 404. Alternatively, the diaphragm 412 in the first electroacoustic transducer 402 may have a diameter D that is larger than the diameter D′ of the diaphragm 414 in the second electroacoustic transducer 404. It is also possible to have the same size diaphragms 412 & 414 and backplates 416 & 418 for both electroacoustic transducers 402 & 404, but the surrounding structure defines different diameters (although the surrounding structure should be made as small as possible, since it takes up space without changing the electroacoustic performance of the transducers 402 & 404). In any case, the difference in diameters causes the two electroacoustic transducers 402 & 404 to have different peak frequencies. Consequently, by careful selection of the diaphragm diameters D and/or D′, a desired resultant peak frequency may be achieved for the microphone 400.

In some embodiments, instead of (or in addition to) the dimensional characteristics, mixing and matching the tensions (i.e., flexibility) and/or thicknesses of the diaphragms may also produce a desired resultant peak frequency. FIG. 5 illustrates a cross-sectional view of a MEMS microphone 500 where the unmatched electroacoustic transducers have diaphragms with different thicknesses. The microphone 500 is similar to the previous microphone assemblies (see FIGS. 1A-1B, 2, 3, 4) in that it includes two electroacoustic transducers 502 & 504 mounted facing each other on opposite sides of a flex-print strip 506. Each electroacoustic transducer 502 & 504 has a respective annular wall 508 & 510 formed therein that defines a cylindrical cavity within each electroacoustic transducer 502 & 504. Flexible diaphragms 512 & 514 and stiff backplates 516 & 518 are disposed within the respective cylindrical cavities substantially parallel to one another and coaxial with each cylindrical cavity. The backplates 516 & 518 have perforations 520 & 522 formed therein for frequency damping purposes. An integrated circuit (not expressly shown) may also be mounted on the flex-print strip 506, either within the cylindrical cavity of one of the electroacoustic transducers 502 & 504 (see FIGS. 1A-1B) or adjacent to one of the electroacoustic transducers 502 & 504 (see FIGS. 2-3).

In accordance with embodiments of the invention, the diaphragms 512 & 514 may have different thicknesses. For example, the diaphragm 512 in the first electroacoustic transducer 502 may have a thickness T that is thinner than a thickness T′ of the diaphragm 514 in the second electroacoustic transducer 504. On the other hand, the diaphragm 512 in the first electroacoustic transducer 502 may have a thickness T that is thicker than the thickness T′ of the diaphragm 514 in the second electroacoustic transducer 504. In either case, the difference in thickness can cause the two electroacoustic transducers 502 & 504 to have different peak frequencies. As a result, by careful selection of the diaphragm thicknesses T and/or T′, a desired resultant peak frequency may be achieved for the microphone 500.

Although not expressly shown, the diaphragms 512 & 514 of FIG. 5 may additionally (or alternatively) have different diaphragm tensions. As mentioned above, the different diaphragm tensions can cause the two electroacoustic transducers 502 & 504 to have different peak frequencies. Accordingly, careful selection of the diaphragm tensions may also (or instead) be used to produce a desired resultant peak frequency for the microphone 500.

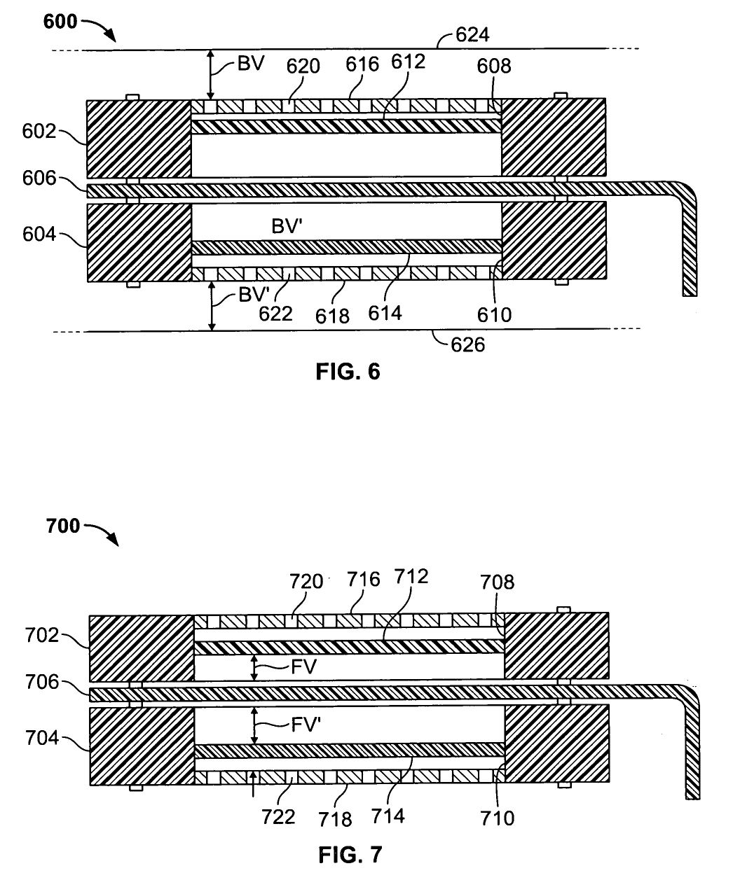

In some embodiments, in addition to (or instead of) adjusting the diameters, tensions, and/or thicknesses of the diaphragms, a desired resultant peak frequency may be achieved by carefully varying the back volumes. The back volume refers to the distance between the backplate and the housing or casing of an electroacoustic transducer. FIG. 6 illustrates a cross-sectional view of a MEMS microphone 600 where the unmatched electroacoustic transducers have different size back volumes. The microphone 600 is similar to the previous microphone assemblies (see FIGS. 1A-1B, 2, 3, 4, 5) in that it includes two electroacoustic transducers 602 & 604 mounted facing each other on opposite sides of a flex-print strip 606. Each electroacoustic transducer 602 & 604 has an annular wall 608 & 610 therein that defines a respective cylindrical cavity within each electroacoustic transducer 602 & 604. Flexible diaphragms 612 & 614 and stiff backplates 616 & 618 are disposed within the cylindrical cavities substantially parallel to one another and coaxial with the cylindrical cavities. Perforations 620 & 622 are formed in the backplates 616 & 618 for frequency damping purposes. An integrated circuit (not expressly shown) may also be mounted on the flex-print strip 606, either within the cylindrical cavity of one of the electroacoustic transducers 602 & 604 (see FIGS. 1A-1B) or adjacent to one of the electroacoustic transducers 602 & 604 (see FIGS. 2-3). A housing or casing, portions of which are shown at 624 & 626, defines a back volume with the backplates 616 and & 618 for each electroacoustic transducer 602 & 604.

In accordance with embodiments of the invention, the electroacoustic transducers 602 & 604 may have different size back volumes. For example, the first electroacoustic transducer 602 may have backup volume BV that is smaller than a back volume BV′ of the second electroacoustic transducer 604. Alternatively, the first electroacoustic transducer 602 may have a back volume BV that is larger than the back volume BV′ of the second electroacoustic transducer 604. In either case, the difference in back volumes sizes can cause the two electroacoustic transducers 602 & 604 to have different peak frequencies. Accordingly, by careful selection of the BV and/or BV′, a desired resultant peak frequency may be achieved for the microphone 600. See also paragraph 37

Note that in the embodiments illustrated by FIG. 6, the sizes of the front volumes of the two electroacoustic transducers 602 & 604 stayed the same. In some embodiments, however, it may be desirable to vary the sizes of front volumes for the two electroacoustic transducers. FIG. 7 illustrates a cross-sectional view of a MEMS microphone 700 according to these embodiments of the invention. The microphone 700 is similar to the previous microphone assemblies (see FIGS. 1A-1B, 2, 3, 4, 5, 6) in that it includes two unmatched electroacoustic transducers 702 & 704 mounted facing each other on opposite sides of a flex-print strip 706. Each electroacoustic transducer 702 & 704 has a respective annular wall 708 & 710 formed therein that defines a cylindrical cavity within each electroacoustic transducer 702 & 704. Flexible diaphragms 712 & 714 and stiff backplates 716 & 718 are disposed within the respective cylindrical cavities substantially parallel to one another and coaxial with each cylindrical cavity. The backplates 716 & 718 have perforations 720 & 722 formed therein for frequency damping purposes.

In accordance with embodiments of the invention, the electroacoustic transducer 702 & 704 may have different sizes of front volumes. The front volume is the space between the diaphragm and the opening of the transducer, indicated by “FV” in FIG. 7. For example, the first electroacoustic transducer 702 may have a front volume FV that is smaller than a front volume FV′ of the second electroacoustic transducer 704. On the other hand, the first electroacoustic transducer 702 may have a front volume FV that is larger than the front volume FV′ of the second electroacoustic transducer 704. In either case, the difference in front volumes causes the two electroacoustic transducers 702 & 704 to have different peak frequencies. Therefore, by careful selection of the front volumes FV and/or FV′, a desired resultant peak frequency may be achieved for the microphone 700. An integrated circuit (not expressly shown) may also be mounted on the flex-print strip 706, either within the front volume of one of the electroacoustic transducers 702 & 704 (see FIGS. 1A-1B) or adjacent to one of the electroacoustic transducers 702 & 704 (see FIGS. 2-3).

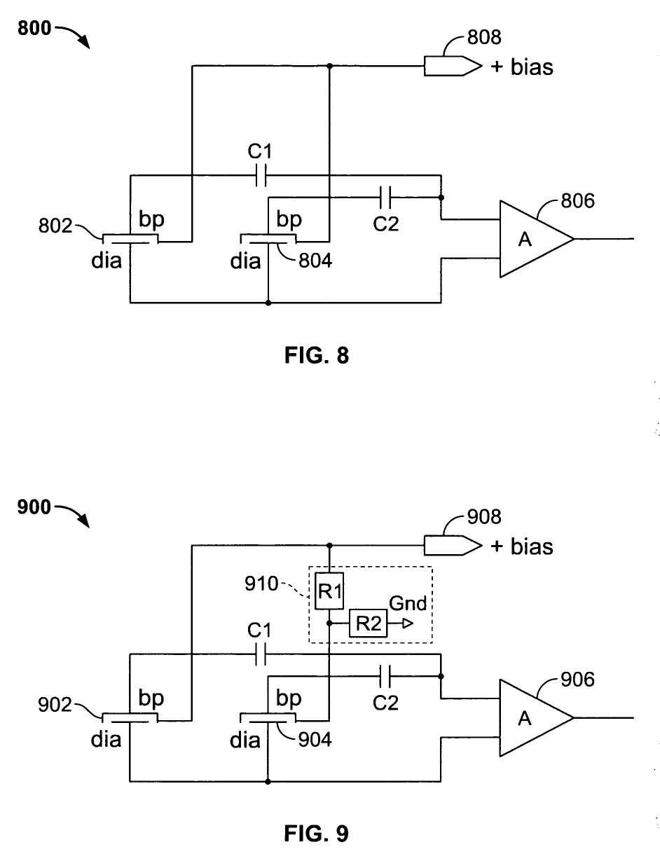

As alluded to above, the integrated circuit provides the charge voltage (also called “bias voltage”) and output signal amplification for the electroacoustic transducers. The bias voltage and output signal amplification are typically in the range of 5-14 volts bias and 6-12 dB gain, but may be selected as needed for a particular application. Note that a digital signal output may be achieved by integrating an analog-to-digital converter into the microphone, either beforehand or after amplification of the output signal. If integrated beforehand, then no further signal amplification is necessary. The digital output signal may then be processes in the digital domain in a manner known to those having ordinary skill in the art. Where amplification is needed or desired, such amplification may be provided by an integrated circuit. The integrated circuit may provide a single bias voltage generator or it may provide several bias voltage generators, and/or there may be one amplifier or there may be multiple amplifiers for the two electroacoustic transducers. FIGS. 8-20 are diagrams illustrating several exemplary bias voltage generator and amplifier arrangements, provided via an integrated circuit similar to the ones shown in FIGS. 1A-1B and 2-7, that may be used in microphone assemblies having dual electroacoustic transducers, similar to those described in FIGS. 1A-1B and 2-7. Those having ordinary skill in the art will understand that other bias voltage generator and amplifier arrangements may also be used without departing from the scope of the invention.

Referring now to FIG. 8, a microphone 800 having an exemplary bias voltage generator and amplifier arrangement for a dual-electroacoustic transducer design according to embodiments of the invention is shown. The microphone 800 includes unmatched electroacoustic transducers 802 & 804 connected in electrical parallel to each other and having substantially the same acoustic sensitivities (e.g., substantially the same diaphragm dimensions and/or tensions) over a certain range of frequencies (i.e., where the sensitivity of the electroacoustic transducer remains relatively flat). The two electroacoustic transducers 802 & 804 are connected to an amplifier 806, which may be, for example, a CMOS source follower voltage amplifier, that is operable to amplify the output signals from the electroacoustic transducers 802 & 804. The amplifier 806 is connected in a single-sided configuration, meaning that one of the inputs (e.g., the negative input) is grounded and only the other input is amplified. A bias voltage generator 808 supplies bias voltages for both electroacoustic transducers 802 & 804, with C1 & C2 serving as coupling capacitors. The bias voltage generator 808 is connected to the electroacoustic transducers 802 & 804 in a manner so as to provide approximately the same voltage magnitudes and polarities to both electroacoustic transducers 802 & 804 (i.e., positive bias voltages are applied to the backplates (“bp”) of the electroacoustic transducers 802 & 804 while the diaphragms (“dia”) are grounded).

Where the unmatched electroacoustic transducers do not have approximately the same acoustic sensitivities, the difference in sensitivities may be corrected by adjusting the bias voltage to each electroacoustic transducer, since acoustic sensitivity changes proportionally to the bias voltage within the useable bias voltage range. FIG. 9 illustrates this aspect of the invention in more detail. In FIG. 9, a microphone 900 includes dual electroacoustic transducers 902 & 904 having different acoustic sensitivities. The dual electroacoustic transducers 902 & 904 are connected in electrical parallel to each other and to an amplifier 906, which may be, for example, a CMOS source follower voltage amplifier arranged in a single-sided configuration. A bias voltage generator 908 is connected to and supplies bias voltages having substantially the same polarities for both electroacoustic transducers 902 & 904, with C1 & C2 again acting as coupling capacitors.

To adjust for the difference in acoustic sensitivities, a voltage divider 910 may be inserted between the electroacoustic transducers 902 & 904 and the bias voltage generator 908. The voltage divider 910 reduces (e.g., by about 40%) the bias voltage magnitude to one of the electroacoustic transducers, for example, the second electroacoustic transducer 904, relative to the other electroacoustic transducer, thereby adjusting for the difference in acoustic sensitivities. Preferably, the voltage divider 910 is a very high impedance circuit (e.g., one that uses active circuit elements), since the bias voltage generator 908 typically has very high impedance. Such a voltage divider 910 may be any suitable voltage divider known to those having ordinary skill in the art, including a resistor-based voltage divider composed of two resistors R1 and R2 connected in the manner shown. The value of the resistors R1 and R2 may then be selected as needed for a particular application.

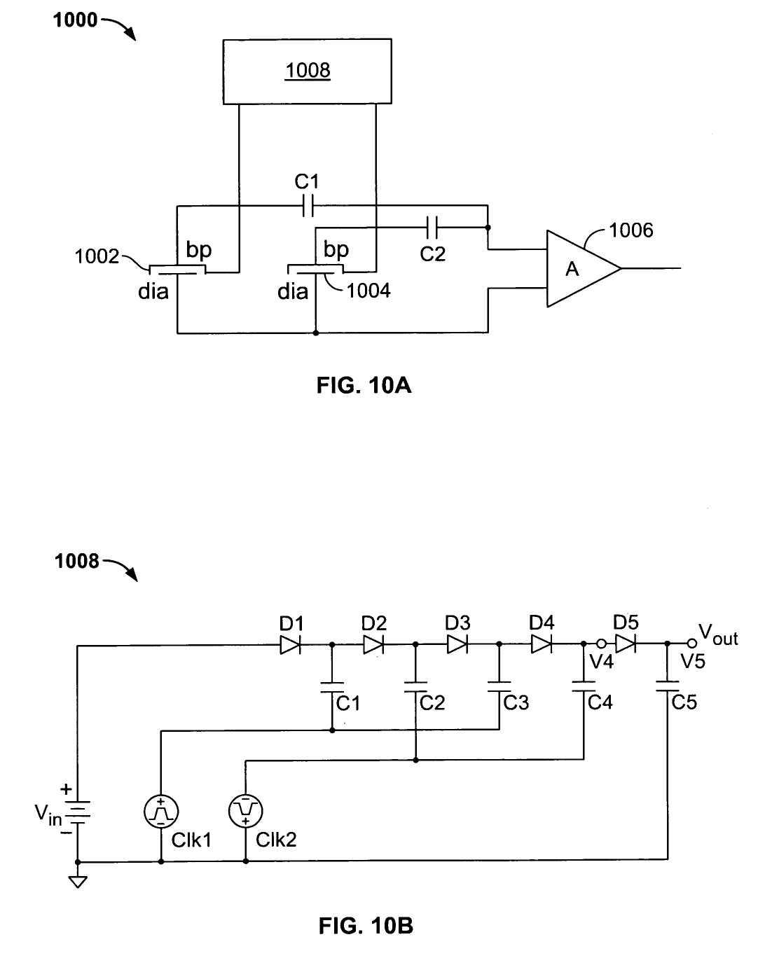

In some embodiments, instead of a voltage divider, “multiplication branches” may be used to correct the difference in acoustic sensitivities of the electroacoustic transducers by tapping the multiplication circuit at different points to obtain the desired bias voltage. Such multiplication branches are sometimes more effective than a voltage divider when confronting very large differences in acoustic sensitivities. FIGS. 10A-10B illustrate this aspect of the invention in more detail. In FIG. 10A, a microphone 1000 includes unmatched dual electroacoustic transducers 1002 & 1004 having different acoustic sensitivities connected in electrical parallel to each other. The electroacoustic transducers 1002 & 1004 are further connected to an amplifier 1006, which may be, for example, a CMOS source follower voltage amplifier arranged in a single-sided configuration.

To correct the difference in acoustic sensitivities, a multiplication branch circuit 1008 may be used to provide the bias voltages for the electroacoustic transducers 1002 & 1004. The electroacoustic transducers 1002 & 1004 may be connected to the multiplication branch circuit 1008 at different branches in order to obtain the desired bias voltage for each electroacoustic transducers 1002 & 1004. FIG. 10B depicts a common multiplication branch circuit 1008 known as a “four-stage Dickson charge pump.” The input to circuit is a DC voltage Vin and the circuit is driven by two anti-phase clocks Clk1 & Clk2, each clock signal Vclk having the same amplitude. The output voltage Vout may be expressed as Vout=Vin+N(Vclk−Vd), where Vd is the voltage drop across each diode D1-D5 and N is the number of diodes. Assuming Vin=Vclk=1V and Vd=0.5V, then Vout=0.5+0.5N. In the embodiment shown, the electroacoustic transducers 1002 & 1004 are connected to the multiplication branch circuit 1008 after the fourth diode D4 (V4) and the fifth diode D5 (V5=Vout), respectively, with V4 being one diode voltage drop lower than V5. It is also possible to tap other branches of the multiplication branch circuit 1008 to balance the sensitivities of the electroacoustic transducers 1002 & 1004 without departing from the scope of the invention.

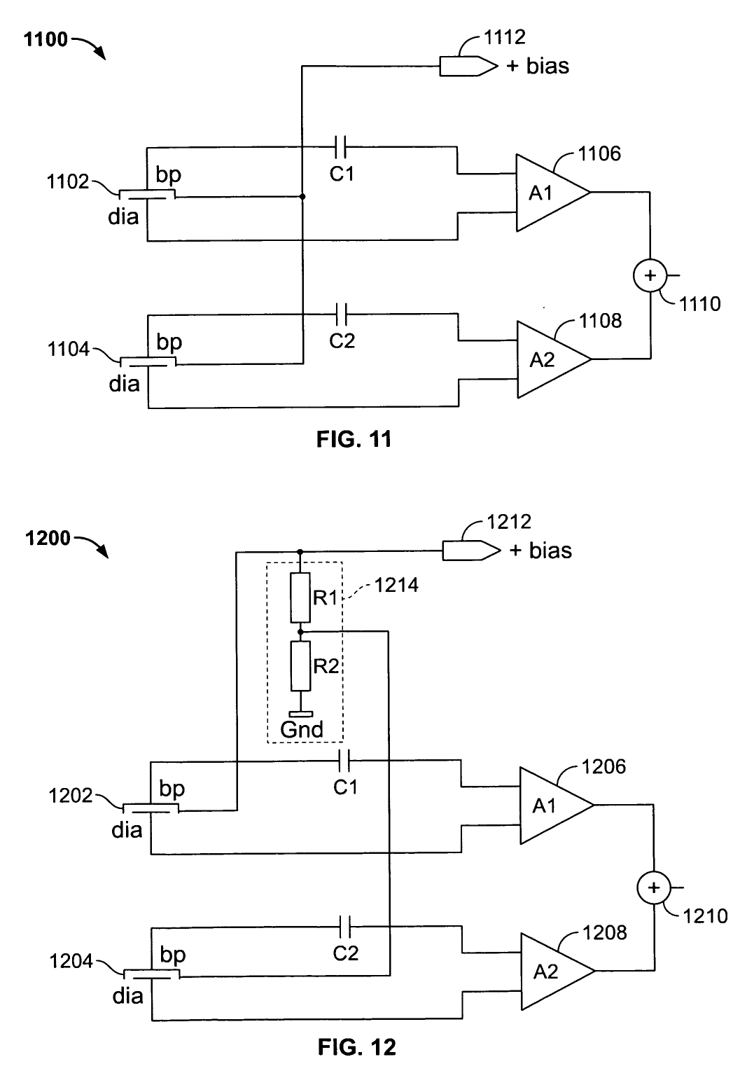

In some embodiments, instead of a single amplifier, two or more amplifiers arranged in a single-sided configuration may be used. Using two amplifiers provides an advantage over a single amplifier for some implementations in terms of the flexibility for routing the electrical signals. For example, the signal lines should be as short as possible in order to minimize impedance. Having a second amplifier may allow the signal lines to follow a much shorter path than would otherwise be possible if only a single amplifier were available. FIG. 11 illustrates this aspect of the invention in more detail. In FIG. 11, a microphone 1100 includes unmatched electroacoustic transducers 1102 & 1104 connected in electrical parallel to each other and having approximately the same acoustic sensitivities. Amplifiers 1106 & 1108, which may be, for example, CMOS source follower voltage amplifiers arranged in single-sided configurations, are connected to the electroacoustic transducers 1102 & 1104 and are operable to amplify the output signals from the electroacoustic transducers 1102 & 1104. The amplifiers 1106 & 1108 preferably have about the same voltage gains (i.e., A1≈A2), but may certainly have voltage gains that are different depending on the application. The outputs of the amplifiers 1106 & 1108 are then connected to a summing node 1110 that operates to combine the output signals from the amplifiers 1106 & 1108 into a single microphone output signal. A bias voltage generator 1112 is connected to and supplies bias voltages having approximately the same magnitudes and polarities for the electroacoustic transducers 1102 & 1104, with C1 & C2 acting as coupling capacitors.

Where the unmatched electroacoustic transducers do not have approximately the same acoustic sensitivities, the difference may be corrected by adjusting the bias voltage to each electroacoustic transducer. FIG. 12 illustrates this aspect of the invention in more detail. In FIG. 12, a microphone 1200 includes unmatched electroacoustic transducers 1202 & 1204 having different acoustic sensitivities connected in electrical parallel to each other. Amplifiers 1206 & 1208, which may be, for example, CMOS source follower voltage amplifiers arranged in single-sided configurations, are connected to the electroacoustic transducers 1202 & 1204, respectively. The amplifiers 1206 & 1208 preferably have about the same voltage gains (i.e., A1≈A2), but it is certainly possible for the voltage gains to be different. The outputs of the amplifiers 1206 & 1208 are connected to a summing node 1210 that operates to combine the output signals from the amplifiers 1206 & 1208 into a single microphone output signal. A bias voltage generator 1212 is connected to and supplies bias voltages having the same polarities for both electroacoustic transducers 1202 & 1204, with C1 & C2 again acting as coupling capacitors.

To adjust for the difference in acoustic sensitivities, a voltage divider 1214 may be inserted in between the electroacoustic transducers 1202 & 1204 and the bias voltage generator 1212. The voltage divider 1214 reduces the bias voltage magnitude to one of the electroacoustic transducers, for example, the second electroacoustic transducer 1204, relative to the other electroacoustic transducer to thereby adjust for the difference in acoustic sensitivities. Such a voltage divider 1214 may be any suitable voltage divider known to those having ordinary skill in the art, including a resistor-based voltage divider composed of two resistors R1 and R2 connected in the manner shown. The sizes of the resistors R1 and R2 may then be selected as needed for a particular application.

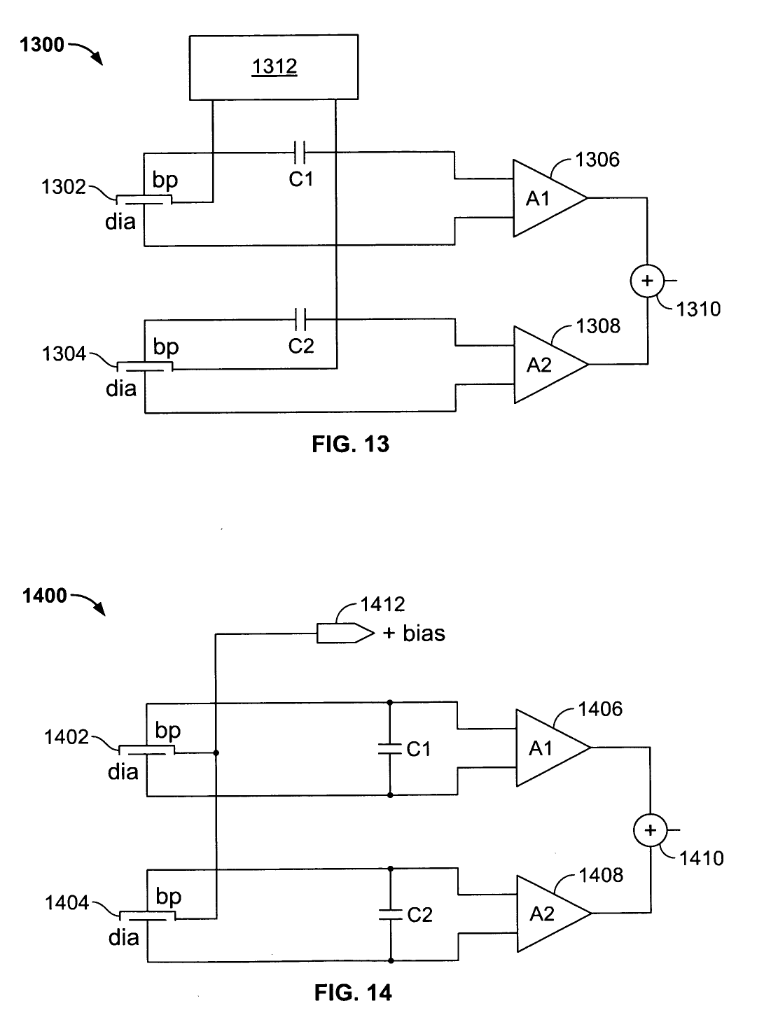

As noted above, sometimes instead of a voltage divider, “multiplication branches” may be used to correct the difference in acoustic sensitivities of the electroacoustic transducers. Such multiplication branches may be more effective for correcting really large differences in acoustic sensitivities than a voltage divider. FIG. 13 illustrates this aspect of the invention in more detail. In FIG. 13, a microphone 1300 includes unmatched electroacoustic transducers 1302 & 1304 having different acoustic sensitivities connected in electrical parallel to each other. The electroacoustic transducers 1302 & 1304 are further connected to amplifiers 1306 & 1308, respectively, which may be, for example, CMOS source follower voltage amplifiers arranged in single-sided configurations. The amplifiers 1306 & 1308 preferably have about the same voltage gains (i.e., A1≈A2), but it is also possible for the voltage gains to be different. The outputs of the amplifiers 1306 & 1308 are connected to a summing node 1310 that combines the output signals from the amplifiers 1306 & 1308 into a single microphone output signal.

To correct the difference in acoustic sensitivities, a multiplication branch circuit 1312 may be used to provide the bias voltages for the electroacoustic transducers 1302 & 1304. The multiplication branch circuit 1312 may be the same as or similar to the multiplication branch circuit 1008 of FIG. 10B and therefore will not be described here. The electroacoustic transducers 1302 & 1304 may then be connected to the multiplication branch circuit 1312 at different branches in order to obtain the desired bias voltage for each electroacoustic transducers 1302 & 1304. In the present embodiment, the electroacoustic transducers 1302 & 1304 may be connected to the multiplication branch circuit 1312 after the fourth diode D4 (V4) and the fifth diode D5 (V5=Vout), respectively, with V4 being one diode voltage drop lower than V5 (see FIG. 10B). Other branches of the multiplication branch circuit may also be tapped to balance the sensitivities of the electroacoustic transducers 1302 & 1304 without departing from the scope of the invention.

In some embodiments, the two amplifiers may have different voltage gains (i.e., A1≠A2), as illustrated in FIG. 14. In FIG. 14, a microphone 1400 includes unmatched electroacoustic transducers 1402 & 1404 connected in electrical parallel to each other and having about the same acoustic sensitivities. Amplifiers 1406 & 1408, which may be, for example, CMOS source follower voltage amplifiers arranged in single-sided configurations, are connected to the electroacoustic transducers 1402 & 1404, respectively. The amplifiers 1406 & 1408 preferably have different voltage gains (i.e., A1≠A2), with the higher gain amplifier 1406 & 1408 applied to the lower sensitivity electroacoustic transducers 1402 & 1404, and vice versa. It is also possible for the voltage gains to be about the same without departing from the scope of the invention. The outputs of the amplifiers 1406 & 1408 are connected to a summing node 1410 that operates to combine the output signals from the amplifiers 1406 & 1408 into a single microphone output signal. A bias voltage generator 1412 is connected to and supplies bias voltages having the same polarities for both electroacoustic transducers 1402 & 1404. In some implementations, coupling capacitors C1 & C2 may be connected in parallel to the electroacoustic transducers 1402 & 1404, respectively, and the amplifiers 1406 & 1408, respectively. The size of the capacitors C1 & C2 may be selected as needed for the particular application in a manner known to those having ordinary skill in the art.

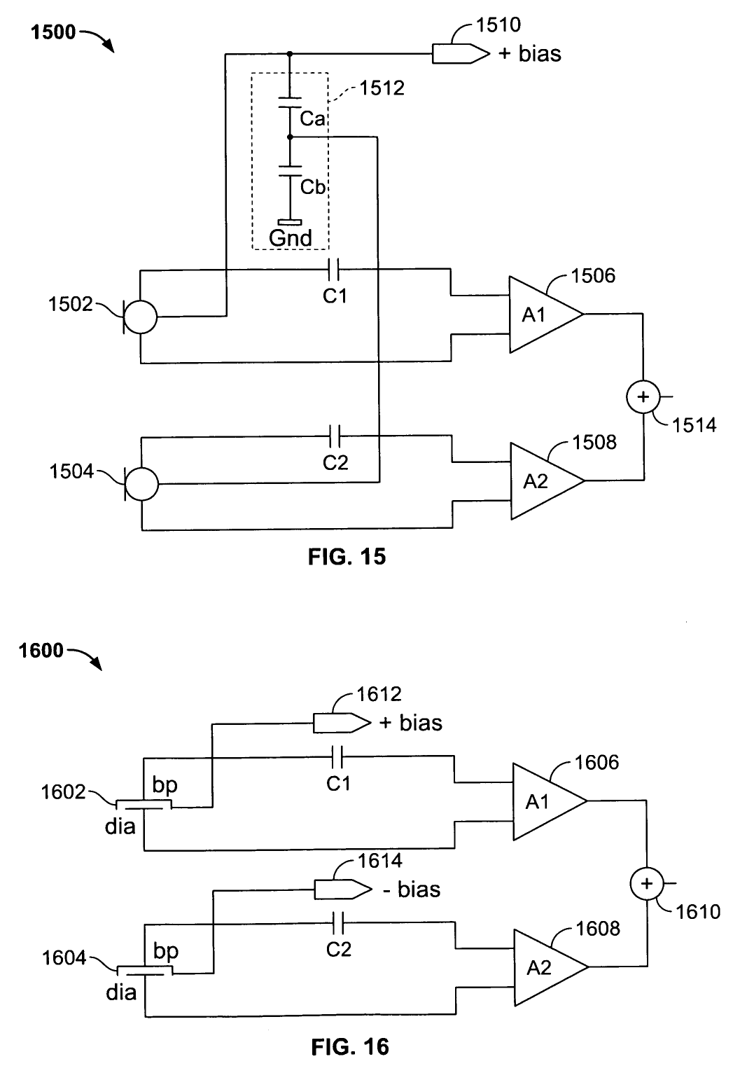

In some cases, really large differences in amplifier voltage gains may be used to adjust for large differences in acoustic sensitivities, as illustrated in FIG. 15. In FIG. 15, a microphone 1500 includes unmatched electroacoustic transducers 1502 & 1504 having different acoustic sensitivities connected in electrical parallel to each other. The electroacoustic transducers 1502 & 1504 are further connected to amplifiers 1506 & 1508, respectively, which may be, for example, CMOS source follower voltage amplifiers arranged in single-sided configurations. A bias voltage generator 1510 is connected to and supplies a bias voltage having the same polarities for both electroacoustic transducers 1502 & 1504, with C1 & C2 again acting as coupling capacitors.

To correct the difference in acoustic sensitivities, the amplifiers 1506 & 1508 preferably have different voltage gains (i.e., A1≠A2), and a capacitive divider 1512 may be inserted in between the electroacoustic transducers 1502 & 1504 and the bias voltage generator 1510. The capacitive divider 1512 reduces the bias voltage magnitude to one of the electroacoustic transducers, for example, the second electroacoustic transducer 1204, relative to the other electroacoustic transducer to thereby adjust for the difference in acoustic sensitivities. Such a capacitive divider 1512 may be any suitable capacitive divider known to those having ordinary skill in the art, including two capacitors Ca and Cb connected in the manner shown. The sizes of the capacitors Ca and Cb may then be selected as needed for the particular application.

In some embodiments, at least two bias voltage generators may be used, one for each electroacoustic transducer. Using separate bias voltage generators for the two electroacoustic transducers provides more flexibility and control over the bias voltages applied to the electroacoustic transducers. FIG. 16 illustrates this aspect of the invention in more detail. In FIG. 16, a microphone 1600 includes unmatched electroacoustic transducers 1602 & 1604 connected in electrical parallel to each other and having approximately the same acoustic sensitivities. The electroacoustic transducers 1602 & 1604 are further connected to amplifiers 1606 & 1608, respectively, which may be, for example, CMOS source follower voltage amplifiers arranged in single-sided configurations. The outputs of the amplifiers 1606 & 1608 are connected to a summing node 1610 that operates to combine the output signals from the amplifiers 1606 & 1608 into a single microphone output signal.

In accordance with embodiments of the invention, at least two bias voltage generators 1612 & 1614 are connected to and supply bias voltages for the electroacoustic transducers 1602 & 1604, respectively. The bias voltage generators 1612 & 1614 preferably have about the same voltage magnitudes, but opposite polarity so that one bias voltage generator, for example, the first bias voltage generators 1612, supplies a positive bias voltage, while the other bias voltage generator supplies a negative bias voltage. In a similar way, in some embodiments, the amplifiers 1606 & 1608 may have about the same voltage gains, but opposite polarity so that one amplifier, for example, the first amplifier 1606, has a positive voltage gain, while the other amplifier has a negative voltage gain. This implementation has been observed to provide improved EMI (electromagnetic interference) protection in some instances relative to other implementations, as explained further below. It is of course also possible to reverse the polarities of the bias voltage generators 1612 & 1614 and/or the amplifiers 1606 & 1608 as needed for a particular application.

In the embodiments described thus far, the amplifiers have been configured as single-sided amplifiers, where one of the inputs to each amplifier is grounded and amplification occurs only for the other input. In some embodiments, double-sided or balanced amplifiers may be used instead of single-sided amplifiers. A balanced amplifier configuration is one where both amplifier inputs receive a signal and the difference between the two signals is then amplified.

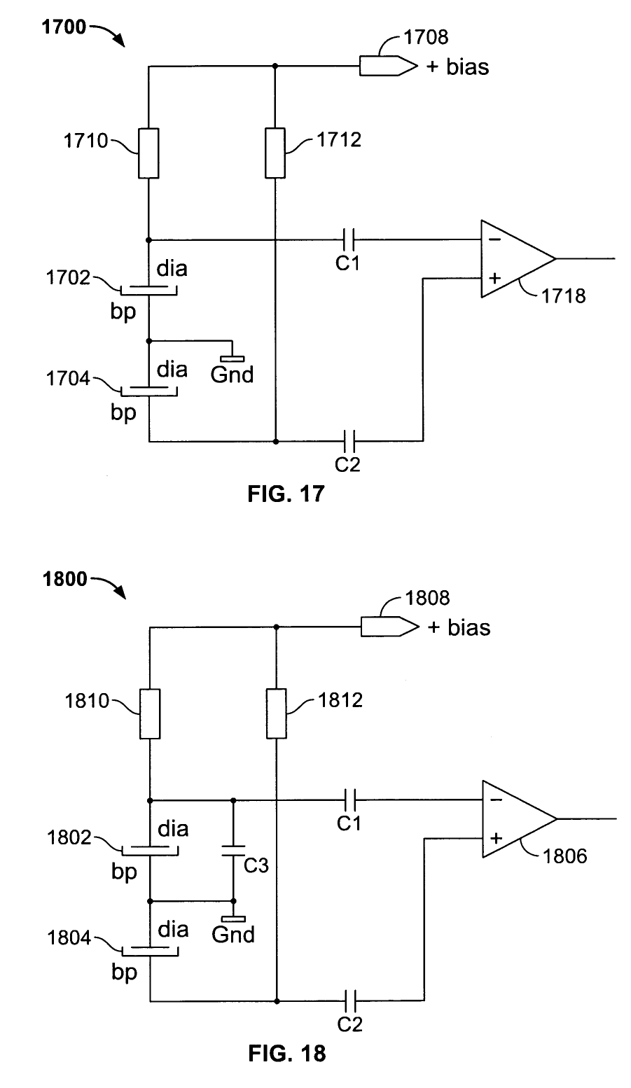

However, as the output signal from each electroacoustic transducer in a dual-electroacoustic transducer arrangement is induced by the same sound wave, the signals are likely to be the same or nearly the same (generally referred to as “common mode” amplification). Therefore, in some embodiments, it may be desirable to reverse the bias voltage of one of the electroacoustic transducers (i.e., apply the bias voltage to the diaphragm and ground the backplate) so that the output signal from that electroacoustic transducer is essentially the mirror image of the output signal from the other electroacoustic transducer (generally referred to as “differential mode” amplification). As mentioned above, reversing the bias voltage for one of the electroacoustic transducers provides an additional benefit in terms of improved EMI protection. The reason is because any EMI in the electroacoustic transducers will not be amplified, but will instead be subtracted by virtue of the reverse biasing. FIGS. 17-20 illustrate embodiments of the invention according to these aspects.

Referring first to FIG. 17, a microphone 1700 includes unmatched electroacoustic transducers 1702 & 1704 having approximately the same acoustic sensitivities and connected in electrical parallel to each other. In some embodiments, the first and second electroacoustic transducers 1702 & 1704 may be MEMS microphone transducers. One of the electroacoustic transducers, for example, the first electroacoustic transducer 1802, has its biasing reversed relative to the other electroacoustic transducer so that their output signals are essentially mirror images.

An amplifier 1706, which may be, for example, a CMOS source follower amplifier arranged in a double-sided configuration, is connected to the electroacoustic transducers 1702 & 1704, respectively, and is operable to amplify the differential signal of the two electroacoustic transducers 1702 & 1704. The amplifier 1706 preferably has a high common-mode rejection ratio (CMRR) so that any signal distortion near the amplifier collapse region is canceled out.

A bias voltage generator 1708 is connected to and supplies bias voltages for both electroacoustic transducers 1702 & 1704. The bias voltage for the electroacoustic transducers 1702 & 1704 may have magnitudes, for example, of about 4 and 20 Volts DC. In some embodiments, pull-up resistors 1710 & 1712 may be inserted between the bias voltage generator 1708 and the electroacoustic transducers 1702 & 1704. Preferably, the sizes of the pull-up resistors 1710 & 1712 are such that the magnitudes of the bias voltages applied to the electroacoustic transducers 1702 & 1704 are approximately the same.

Capacitors C1 & C2 may also be employed as DC coupling capacitors in some embodiments between the electroacoustic transducers 1702 & 1704 and the amplifier 1706. Such DC coupling capacitors may comprise, for example, an integrated circuit poly-poly capacitor having a lower and an upper capacitor plate. The integrated circuit poly-poly capacitor may, in turn, comprise a substrate material and an electrically floating well-area arranged below the lower capacitor plate. The value of the pull-up resistors 1710 & 1712 and capacitors C1 & C2 may then be selected as needed for a particular application.

Where the electroacoustic transducers do not have approximately the same acoustic sensitivities, the difference in the sensitivities may be corrected by adjusting the bias voltage to one or both electroacoustic transducers. FIG. 18 illustrates this aspect of the invention in more detail. In FIG. 18, a microphone 1800 includes unmatched electroacoustic transducers 1802 & 1804 having different acoustic sensitivities. The dual electroacoustic transducers 1802 & 1804 are connected in electrical parallel to each other, but with one electroacoustic transducer, for example, the first electroacoustic transducer 1802, having its biasing reversed relative to the other electroacoustic transducer. An amplifier 1806, which may be, for example, a CMOS source follower amplifier arranged in a double-sided configuration, is connected to the electroacoustic transducers 1802 & 1804, respectively. As before, the amplifier 1806 preferably has a high common-mode rejection ratio so that any signal distortion near the amplifier collapse region is canceled out. A bias voltage generator 1808 is connected to and supplies bias voltages for both electroacoustic transducers 1802 & 1804. Pull-up resistors 1810 & 1812 may be inserted between the bias voltage generator 1808 and the electroacoustic transducers 1802 & 1804 in some embodiments, and capacitors 1814 & 1816 may also be employed between the electroacoustic transducers 1802 & 1804 and the amplifier 1806 in some embodiments. The sizes of the pull up resistors 1810 & 1812 and capacitors 1814 & 1816 may be selected as needed for a particular application.

To adjust for the difference in acoustic sensitivities, a capacitor C3 may be connected across one of the electroacoustic transducers, for example, the first electroacoustic transducer 1802. This capacitor functions as a capacitive voltage divider, so that the effective sensitivity of the first electroacoustic transducer 1802 is lower. The size of the capacitor C3 may be selected as needed for a particular application.

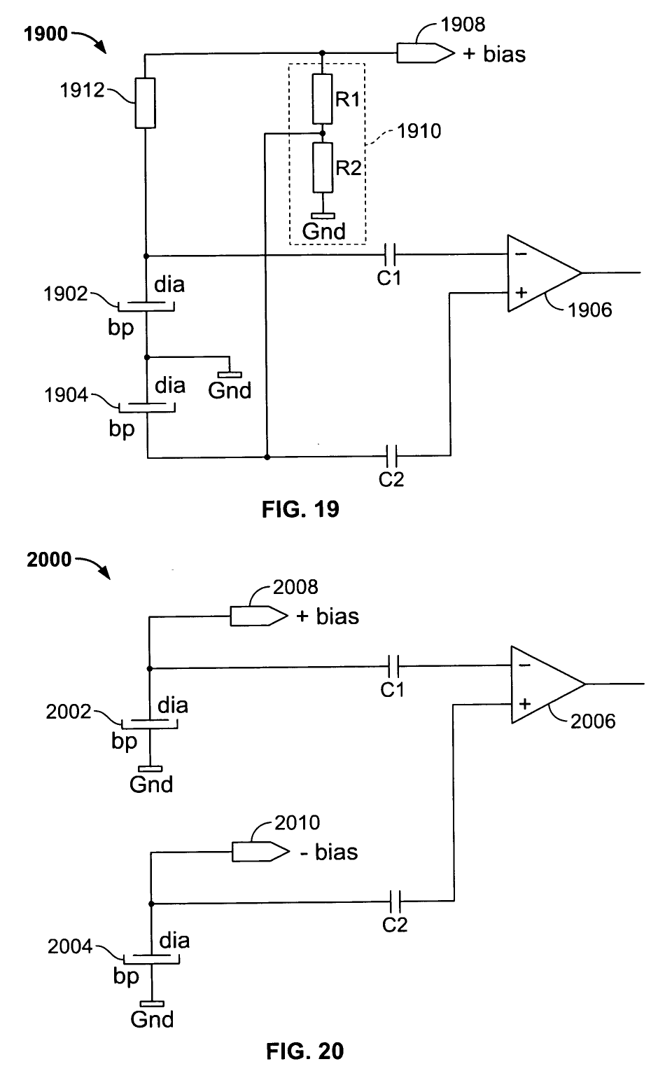

In some embodiments, instead of a capacitor connected across one of the electroacoustic transducers, a voltage divider may be used to correct the difference in acoustic sensitivities. FIG. 19 illustrates this aspect of the invention in more detail. In FIG. 19, a microphone 1900 includes unmatched electroacoustic transducers 1902 & 1904 having different acoustic sensitivities. The dual electroacoustic transducers 1902 & 1904 are connected in electrical parallel to each other, but with one electroacoustic transducer, for example, the first electroacoustic transducer 1902, having its biasing reversed relative to the other electroacoustic transducer. An amplifier 1906, which may be, for example, a CMOS source follower amplifier arranged in a double-sided or balanced configuration, is connected to the electroacoustic transducers 1902 & 1904, respectively. As above, the amplifier 1906 preferably has a high common-mode rejection ratio so that any signal distortion near the amplifier collapse region is canceled out. A bias voltage generator 1908 is connected to and supplies bias voltages for both electroacoustic transducers 1902 & 1904.

In accordance with embodiments of the invention, a voltage divider 1910 is inserted between the bias voltage generator 1908 and on of the electroacoustic transducers, for example, the second electroacoustic transducer 1904. The voltage divider 1910 reduces (e.g., halves) the bias voltage to the second electroacoustic transducer 1904 relative to the first electroacoustic transducer 1902, thereby correcting the difference in acoustic sensitivities. Such a voltage divider 1910 may be any suitable voltage divider known to those having ordinary skill in the art, including a resistor-based voltage divider composed of two resistors R1 and R2 connected in the manner shown. In some embodiments, a pull-up resistor 1912 may be inserted between the bias voltage generator and the other electroacoustic transducer 1902, and DC coupling capacitors C1 & C2 may be employed between the electroacoustic transducers 1902 & 1904 and the amplifier 1906. The sizes of the voltage divider resistors R1 and R2, pull-up resistor 1912, and capacitors C1 & C2 may be selected as needed depending on the particular application.

In some embodiments, rather than use a voltage divider to adjust the bias voltage applied to one of the electroacoustic transducers, separate bias voltage generators may be provided for each electroacoustic transducer. In this way, the bias voltage for each electroacoustic transducer may be independently controlled by that electroacoustic transducer's respective bias voltage generator. FIG. 20 illustrates this aspect of the invention in more detail. In FIG. 20, a microphone 2000 includes unmatched electroacoustic transducers 2002 & 2004 having different acoustic sensitivities connected in electrical parallel to each other. An amplifier 2006, which may be, for example, a CMOS source follower amplifier arranged in a double-sided configuration, is connected to the electroacoustic transducers 2002 & 2004, respectively. As above, the amplifier 2006 preferably has a high common-mode rejection ratio so that any signal distortion near the amplifier collapse region is canceled out. A bias voltage generator 2008 is connected to and supplies bias voltages for both electroacoustic transducers 2002 & 2004, with capacitors C1 & C2 surfing has coupling capacitors.

In accordance with embodiments of the invention, the biasing of both electroacoustic transducers 2002 & 2004 has been reversed. Furthermore, one of the electroacoustic transducers, for example, the second electroacoustic transducer 2004, is provided with a negative bias voltage, while the other electroacoustic transducer receives a positive bias voltage. This arrangement allows the bias voltage for each electroacoustic transducer to be independently controlled (i.e., no pull-up resistors are needed) while generating a differential signal to the amplifier 2006. The differential signal is then amplified by the amplifier 2006 and provided as the microphone output signal.

In addition to compensating for differences in sensitivities, the microphone 2000 in FIG. 20 has numerous other benefits as well, including enhanced EMI protection, improved noise cancellation, higher CMRR, and the like. These benefits arise by virtue of the arrangement of the transducers 2002 & 2004 regardless of whether the transducers are matched or unmatched and regardless of whether they are MEMS transducers, ECM transducers, or some other type of transducers. In general, in accordance with embodiments of the invention, any microphone assembly comprising two or more transducers may have the above benefits provided the transducers: (1) are connected in electrical parallel with each other, (2) have opposite biasing polarity, and (3) the outputs of the transducers are summed using a double-sided amplifier configuration, as shown in FIG. 20.

While the present invention has been described with reference to one or more particular embodiments, those skilled in the art will recognize that many changes may be made thereto without departing from the spirit and scope of the invention. For example, while MEMS microphone assemblies have been described herein, various embodiments of the invention are fully applicable to traditional ECM microphone assemblies as well. Furthermore, while microphone assemblies having two unmatched electroacoustic transducers have been described herein, microphone assemblies having three or more unmatched electroacoustic transducers may also be used. Therefore, each of the foregoing embodiments and obvious variations thereof is contemplated as falling within the spirit and scope of the claimed invention, which is set forth in the following claims.

What is claimed is:

1. A microphone assembly, comprising:
a first electroacoustic transducer having a first peak frequency; and
a second electroacoustic transducer having a second peak frequency and connected in electrical parallel with said first electroacoustic transducer, said second peak frequency being substantially different from said first peak frequency by a predetermined minimum amount;
wherein said first peak frequency and said second peak frequency produce a desirable resultant peak frequency for said microphone assembly.

2. The assembly according to claim 1, wherein said first peak frequency and said second peak frequency are substantially symmetrical about said resultant frequency.

3. The assembly according to claim 1, wherein said first peak frequency and said second peak frequency have substantially equal amplitudes.

4. The assembly according to claim 1, wherein said predetermined minimum distance is between approximately 0.72 times said resultant frequency and approximately 0.40 times said resultant frequency.

5. The assembly according to claim 1, further comprising a substrate, wherein said first electroacoustic transducer is mounted on one side of said substrate and said second electroacoustic transducer is mounted on another side of said substrate across from said first electroacoustic transducer.

6. The assembly according to claim 5, further comprising an integrated circuit mounted on said substrate, said integrated circuit providing a biasing voltage and output signal amplification for said first and second electroacoustic transducers.

7. The assembly according to claim 6, wherein said first and second electroacoustic transducers each have a front volume and said integrated circuit is mounted on said substrate within said front volume of one of said first and said second electroacoustic transducers.

8. The assembly according to claim 6, wherein said integrated circuit is mounted on said substrate adjacent to one of said first and second electroacoustic transducers.

9. The assembly according to claim 6, wherein one of said first and second electroacoustic transducers has a package size that is smaller than a package size of the other one of said first and second electroacoustic transducers and said integrated circuit is mounted on said substrate adjacent to said one of said first and second electroacoustic transducers having said smaller package size.

10. The assembly according to claim 1, wherein one of said first and second electroacoustic transducers has a flexible diaphragm formed therein having at least one characteristic that is different from a flexible diaphragm formed in the other one of said first and second electroacoustic transducers.

11. The assembly according to claim 10, wherein said at least one characteristic includes one or more of: diameter, length, width, thickness, and tension.

12. The assembly according to claim 1, wherein one of said first and second electroacoustic transducers has a back volume formed therein that is different from a back volume formed in the other one of said first and second electroacoustic transducers.

13. The assembly according to claim 1, wherein one of said first and second electroacoustic transducers has a front volume formed therein that is different from a front volume formed in the other one of said first and second electroacoustic transducers.

14. The assembly according to claim 2, wherein said substrate is one of the following types of substrates: a flex-print strip, a printed circuit board, and a silicon-based layer.

15. The assembly according to claim 1, wherein said resultant peak frequency is between approximately 9 kHz and 15 kHz.

16. A microphone, comprising:
a first electroacoustic transducer having a first peak frequency; and
a second electroacoustic transducer having a second peak frequency and connected in electrical parallel to said first electroacoustic transducer, said second peak frequency being substantially different from said first peak frequency by a predetermined minimum amount;
at least one voltage generator connected to one or more of said first and second electroacoustic transducers; and
at least one amplifier connected to one or more of said first and second electroacoustic transducers;
wherein said first peak frequency and said second peak frequency produce a desirable resultant peak frequency for said microphone assembly.

17. The microphone according to claim 16, wherein said first and second electroacoustic transducers have approximately the same acoustic sensitivities and said at least one voltage generator comprises a single voltage generator, said single voltage generator supplying a same biasing voltage for both said first and second electroacoustic transducers.

18. The microphone according to claim 16, wherein said first and second electroacoustic transducers have different acoustic sensitivities and said at least one voltage generator comprises a single voltage generator, said single voltage generator supplying a different biasing voltage to each one of said first and second electroacoustic transducers.

19. The microphone according to claim 17, wherein said single voltage generator supplies said different biasing voltage to each one of said first and second electroacoustic transducers using one of the following: a voltage divider and multiplication branches.

20. The microphone according to claim 17, wherein said at least one amplifier comprises a first amplifier connected to said first electroacoustic transducer and a second amplifier connected to said second electroacoustic transducer.

21. The microphone according to claim 17, wherein said at least one amplifier comprises a first amplifier connected to said first electroacoustic transducer and a second amplifier connected to said second electroacoustic transducer.

22. The microphone according to claim 21, wherein said single voltage generator supplies said different biasing voltage to each one of said first and second electroacoustic transducers using one of the following: a voltage divider and multiplication branches.

23. The microphone according to claim 20, wherein said first amplifier has a first amplifier gain and said second amplifier has a second amplifier gain, said second amplifier gain being different from said first amplifier gain.

24. The microphone according to claim 23, wherein said first and second amplifier gains are achieved using a capacitive divider.

25. The microphone according to claim 16, wherein said first and second electroacoustic transducers have approximately the same acoustic sensitivities, but opposite biasing polarities, said at least one voltage generator comprising a single voltage generator, said single voltage generator supplying a same biasing voltage for both said first and second electroacoustic transducers.

26. The microphone according to claim 16, wherein said first and second electroacoustic transducers have different acoustic sensitivities and opposite biasing polarities, said at least one voltage generator comprising a single voltage generator, said single voltage generator supplying a different biasing voltage to each one of said first and second electroacoustic transducers.

27. The microphone according to claim 27, wherein said single voltage generator supplies said different biasing voltage to each one of said first and second electroacoustic transducers using one of the following: a voltage divider and a capacitive circuit element connected across one of said first and second electroacoustic transducers.

28. The microphone according to claim 16, wherein said first and second electroacoustic transducers have different acoustic sensitivities and opposite biasing polarities, said at least one voltage generator comprising a first voltage generator connected to said first silicon base electroacoustic transducer and a second voltage generator connected to said second electroacoustic transducer.

29. The microphone according to claim 28, wherein said opposite biasing polarities provide improved electromagnetic interference (EMI) protection for said microphone.

30. A method of assembling a microphone, comprising:
mounting a first electroacoustic transducer having a first peak frequency on a substrate; and
mounting a second electroacoustic transducer having a second peak frequency on said substrate in electrical parallel to said first electroacoustic transducer, said second peak frequency being substantially different from said first peak frequency by a predetermined minimum amount;
wherein said first peak frequency and said second peak frequency produce a desirable resultant peak frequency for said microphone assembly.

31. The method according to claim 30, wherein said first electroacoustic transducer is mounted on one side of said substrate and said second electroacoustic transducer is mounted on another side of said substrate across from said first electroacoustic transducer.

32. The method according to claim 30, further comprising:
connecting at least one voltage generator to one or more of said first and second electroacoustic transducers; and
connecting at least one amplifier to one or more of said first and second electroacoustic transducers.

33. A microphone assembly, comprising:
a first electroacoustic transducer adapted to produce a first electrical output signal; and
a second electroacoustic transducer adapted to produce a second electrical output signal,
one or more bias voltage generators adapted to provide first and second DC bias voltages of opposing polarity to said first and second electroacoustic transducers, respectively; and
an amplifier electrically connected to the first and second electrical output signals to provide an amplifier output signal derived from the first and second electrical output signals.

34. The microphone assembly according to claim 33, wherein the amplifier comprises a differential amplifier having a first input connected to the first electrical output signal and a second input connected to the second electrical output signal.

35. The microphone assembly according to claim 33, wherein the first and second electrical output signals are connected to the amplifier through respective DC coupling capacitors.

36. The microphone assembly according to claim 33, wherein said DC coupling capacitors comprise an integrated circuit poly-poly capacitor having a lower and an upper capacitor plate, and wherein the integrated circuit poly-poly capacitor comprises a substrate material and a electrically floating well-area arranged below the lower capacitor plate.

37. The microphone assembly according to claim 36, wherein the first and second DC bias voltages are of substantially equal magnitude.

38. The microphone assembly according to claim 33, wherein the first and second electroacoustic transducers comprise respective MEMS microphone transducers having respective magnitudes of the DC bias voltage of 4 and 20 Volts.
